(19) United States
(12) Patent Application Publication
(10) Pub. No.: US 2011/0143821 A1
(43) Pub. Date: Jun. 16, 2011

(54) POWER AMPLIFICATION MODULE FOR MOBILE COMMUNICATION TERMINAL

(76) Inventors: Hyeon Seok HWANG, Seoul (KR); Yoo Sam Na, Seoul (KR); Moon Suk Jeong, Gyunggi-do (KR); Byeong Hak Jo, Gyunggi-do (KR)

(21) Appl. No.: 12/714,118

(22) Filed: Feb. 26, 2010

(30) Foreign Application Priority Data
Dec. 15, 2009 (KR) 10-2009-0124908

(51) Int. Cl. H04M 1/00

(52) U.S. Cl. 455/571

(57) ABSTRACT

Disclosed herein is a power amplification module for a mobile communication terminal. The power amplification module includes a balanced power amplifier configured to divide an input signal using a phase difference, amplify resulting signals, and combine the amplified signals with each other, and a transmission power detection unit connected to an isolation terminal formed on an output side of the balanced power amplifier and configured to amplify a micro-power signal, which is transmitted to the isolation terminal from an outside of the transmission power detection unit, and to transmit the amplified signal. Accordingly, since the detection signal to input terminal and detection signal output terminal of a transmission power detection unit can be easily implemented using an internal circuit, the entire size of the power amplification module can be reduced. Further, characteristic of isolation between the detection signal input terminal and the detection signal output terminal can be improved.

### CROSS REFERENCE TO RELATED APPLICATION

This application claims the benefit of Korean Patent Application No. 10-2009-0124908, filed on Dec. 15, 2009, entitled “Power Amplification Module of The Mobile Communication Device”, which is hereby incorporated by reference in its entirety into this application.

### BACKGROUND OF THE INVENTION

1. Technical Field

The present invention relates to a power amplification module for a mobile communication terminal.

2. Description of the Related Art

Recently, as the communication mode of mobile communication terminals has been becoming diversified, a plurality of power amplifiers have been used in mobile communication terminals so as to support multi-mode communication such as Global System for Mobile communications (GSM) mode, Enhanced Data for Global Evolution (EDGE) mode, and Wideband Code Division Multiple Access (WCDMA) mode communication.

However, since a baseband communication chip which controls a plurality of power amplifiers supporting multi-mode communication, as described above, is implemented and used as only a single chip, pieces of information about the intensities of signals (that is, the intensity of transmission power) output from a plurality of power amplifiers (for example, power amplifiers 110a, 110b and 110c corresponding to GSM, EDGE and WCDMA modes) are collected and transmitted to the baseband chip, as shown in FIG. 1.

In this case, since, due to the characteristics of the power amplifiers, the properties of the signals transmitted to the baseband chip are deteriorated when other ports or paths are formed at the output terminals of the power amplifiers, most of the signals are not directly connected, but are transmitted to the baseband chip by couplers 120a, 120b and 120c using magnetic fields.

The couplers 120a, 120b and 120c are generally designed to be of the external mounting-type. A signal coupled by the couplers 120a, 120b and 120c (that is, a transmission power detection signal) has a magnitude of about −20 dB of the intensity of the signal output from the power amplifiers 110a, 110b and 110c through an antenna.

Meanwhile, when the signal coupled by the couplers 120a, 120b and 120c is transmitted to the baseband chip, the baseband chip controls the output power (transmission power) of the power amplifiers 110a, 110b and 110c using the received coupled signal.

The reason for this is that, as a mobile communication terminal becomes farther away from a base station, electric field strength (Received Signal Strength Indicator: RSSI) decreases, and thus an error rate for signals increases.

Accordingly, the baseband chip controls the output power of the power amplifiers 110a, 110b and 110c in proportion to the distance between the mobile communication terminal and the base station by using the signal coupled by the couplers 120a, 120b and 120c so as to reduce an error rate for signals.

Since, in this way, external mounting-type couplers are interposed between the output terminals of power amplifiers and antennas and configured to detect the transmission power of the mobile communication terminal in the related art, the cost increases due to the use of external elements, and, in addition, insertion loss occurs due to the interposition of external mounting-type couplers between the output terminals of power amplifiers and antennas.

Further, in the related art, since couplers, the input terminal (in) and the output terminal (out) of each of which have bidirectionality, are used, there is a problem in that the output signal of a relevant coupler is output both through the input terminal and the output terminal of the coupler, and is then input to the output terminal of the coupler of another power amplifier, thus negatively influencing the overall signal characteristics.

### SUMMARY OF THE INVENTION

Accordingly, the present invention has been made keeping in mind the above problems occurring in the prior art, and the present invention is intended to provide a power amplification module for a mobile communication terminal, which enables couplers to be easily implemented and which can reduce the cost required for the couplers and can ensure the characteristic of isolation between the input and output of the couplers.

In accordance with an aspect of the present invention, there is provided a power amplification module for a mobile communication terminal, comprising a balanced power amplifier configured to divide an input signal using a phase difference, amplify resulting signals, and combine the amplified signals with each other; and a transmission power detection unit connected to an isolation terminal formed on an output side of the balanced power amplifier and configured to amplify a micro-power signal, which is transmitted to the isolation terminal from an outside of the transmission power detection unit, and to transmit the amplified signal to the outside.

In an embodiment, the balanced power amplifier comprises a first branch-line coupler for dividing the input signal into two signals having an identical magnitude and a phase difference of 90° therebetween; first amplification means and second amplification means for respectively amplifying the two signals divided by the first branch-line coupler; and a second branch-line coupler for combining the signals amplified by the first amplification means and the second amplification means with each other.

In an embodiment, the signals divided by the first branch-line coupler each have a magnitude which is ½ of power intensity of the input signal. In an embodiment, the transmission power detection unit comprises a buffer for transferring an externally received transmission power detection signal; and an amplification unit connected to the isolation terminal of the balanced power amplifier and connected to the buffer in a cascode structure, the amplification unit amplifying a signal transferred to the isolation terminal of the balanced power amplifier and transmitting the amplified signal to the outside of the transmission power detection unit when the buffer is operated.

In an embodiment, the buffer comprises a first transistor, a drain of which is connected to supply power, a source of which is connected to the amplification unit, and a gate of which is connected to a transmission power detection signal input terminal for receiving the transmission power detection signal; and a first capacitor connected between the gate of the first transistor and the transmission power detection signal input terminal so as to eliminate a Direct Current (DC) component of the transmission power detection signal.

In an embodiment, the amplification unit comprises a second transistor, a drain of which is connected to the source of the first transistor, a source of which is connected to a ground, and a gate of which is connected to the isolation terminal; a second capacitor connected between the isolation terminal and the gate of the second transistor and configured to eliminate a DC component of a signal received from the isolation terminal; and a third capacitor connected between a common node of the source of the first transistor and the drain of the second transistor and a transmission power detection signal output terminal.

In an embodiment, each of the first transistor and the second transistor is implemented as an N-type Metal-Oxide-Semiconductor Field-Effect Transistor (NMOSFET).

### BRIEF DESCRIPTION OF THE DRAWINGS

FIG. 1 is a diagram showing a conventional power amplification module for a mobile communication terminal;

FIG. 2 is a diagram showing a power amplification module for a mobile communication terminal according to an embodiment of the present invention;

FIG. 3 is a diagram showing the branch-line coupler of FIG. 2;

FIG. 4 is a diagram showing an equivalent circuit of the branch-line coupler of FIG. 3;

FIGS. 5 and 6 are graphs showing the characteristics of the branch-line coupler of FIG. 2; and

FIGS. 7 and 8 are graphs showing the characteristics of the power amplification module of FIG. 2.

### DESCRIPTION OF THE PREFERRED EMBODIMENTS

Prior to giving the description, the terms and words used in the present specification and claims should not be interpreted as being limited to their typical meaning based on the dictionary definitions thereof, but should be interpreted to have the meaning and concept relevant to the technical spirit of the present invention, on the basis of the principle by which the inventor can suitably define the implications of terms in the way which best describes the invention.

The above and other objects, features and advantages of the present invention will be more clearly understood from the following detailed description taken in conjunction with the accompanying drawings. In the present specification, reference now should be made to the drawings, in which the same reference numerals are used throughout the different drawings to designate the same or similar components. Further, the above terms are used to distinguish one component from the other component, and the components of the present invention are not limited by the terms. Further, in the description of the present invention, if detailed descriptions of related well-known constructions or functions are determined to make the gist of the present invention unclear, the detailed descriptions will be omitted.

Hereinafter, embodiments of the present invention will be described in detail with reference to the attached drawings.

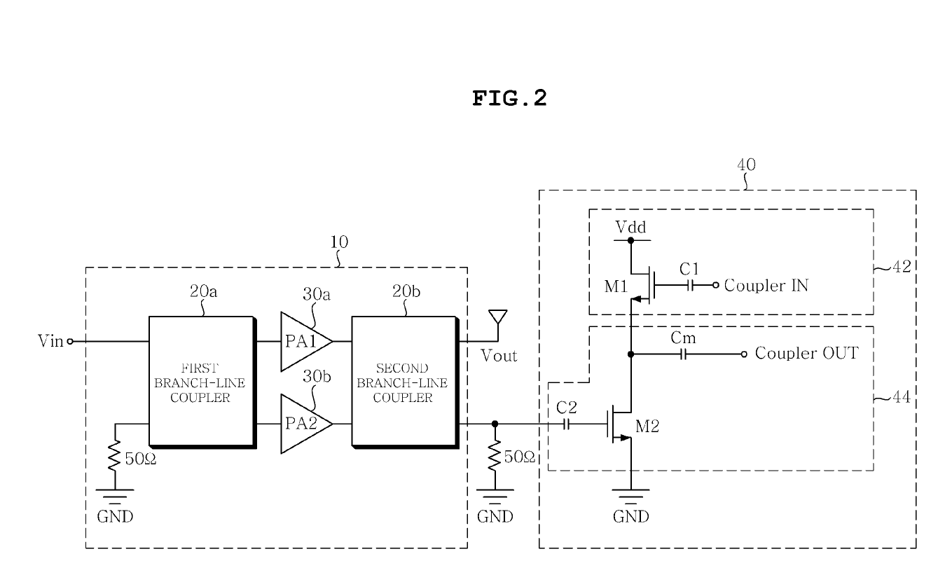

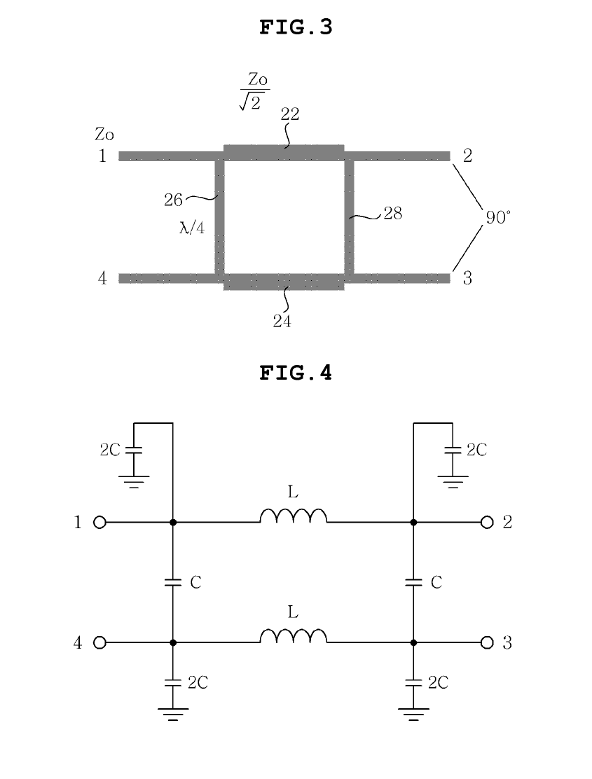

FIG. 2 is a diagram showing a power amplification module for a mobile communication terminal according to an embodiment of the present invention, FIG. 3 is a diagram showing the branch-line coupler of FIG. 2, and FIG. 4 is a diagram showing an equivalent circuit of the branch-line coupler of FIG. 3.

As shown in FIG. 2, a power amplification module for a mobile communication terminal according to an embodiment of the present invention includes a balanced power amplifier 10 and a transmission power detection unit 40.

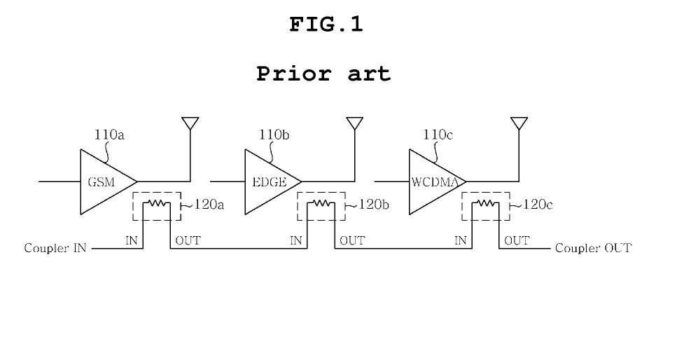

The balanced power amplifier 10 is a component replacing any one of a Global System for Mobile communications (GSM) power amplifier 110a, an Enhanced Data for Global Evolution (EDGE) power amplifier 110b, and a Wideband Code Division Multiple Access (WCDMA) power amplifier 110c which are shown in FIG. 1. The transmission power detection unit 40 is a component replacing any one of couplers 120a, 120b and 120c which are shown in FIG. 1.

Accordingly, those skilled in the art will appreciate that the power amplification module described in the present invention is intended to describe only one of pairs of power amplifiers 110a, 110b, and 110c and couplers 120a, 120b and 120c, and also that a single power amplification module according to the present invention does not support all of GSM, EDGE and WCDMA communication.

The balanced power amplifier 10 divides an input signal Vin using a phase difference, amplifies the resulting signals, and combines the amplified signals with each other.

For this operation, the balanced power amplifier 10 includes a first branch-line coupler 20a and a second branch-line coupler 20b, respectively connected to an input terminal Vin and an output terminal Vout, and amplification means 30a and 30b connected between the first and second branch-line couplers 20a and 20b and configured to amplify the output signal of the first branch-line coupler 20a.

The first branch-line coupler 20a connected to the input terminal Vin functions as a splitter for dividing the input signal Vin. The second branch-line coupler 20b connected to the output terminal Vout functions as a combiner for combining the signals amplified by the amplification means 30a and 30b with each other.

Each of the first branch-line coupler 20a and the second branch-line coupler 20b is implemented as a four terminal network, as shown in FIG. 3, and is composed of lumped elements, that is, inductors and capacitors, as shown in FIG. 4.

In this case, the length of each of a first series transmission line 22, a second series transmission line 24, a first shunt transmission line 26, and a second shunt transmission line 28 is λ/4 of a center frequency f0.

Further, the first and second series transmission lines 22 and 24 are formed to be vertically symmetrical and the first and second shunt transmission lines 26 and 28 are formed to be horizontally symmetrical.

When the electric length of each of the first series transmission line 22, the second series transmission line 24, the first shunt transmission line 26 and the second shunt transmission line 28 is λ/4 of the center frequency f0, as described above, the first and second series transmission lines 22 and 24 are set to have a characteristic impedance of 35Ω, and the first and second shunt transmission lines 26 and 28 are set to have a characteristic impedance of 50Ω.

The branch-line couplers 20a and 20b, each having the above construction, are configured such that, when a signal is input through a single port, the first and second series transmission lines 22 and 24 divide the input signal into two signals, each having a magnitude which is ½ of the power intensity of the input signal, and modulate the phases of the two signals so that the two signals have a phase difference of 90°.

However, when signals are input through two ports, the first and second series transmission lines 22 and 24 combine the two signals with each other.

That is, when the branch-line coupler 20a or 20b is installed at the input terminal to perform the function of a splitter, a first port 1 is used as the input terminal Vin, a second port 2 and a third port 3 are used as the output terminal, and a fourth port 4 is used as an isolation terminal.

Further, when the branch-line coupler 20a or 20b is installed at the output terminal Vout to perform the function of a combiner, the first port 1 is used as the output terminal, the second and third ports 2 and 3 are used as the input terminal, and the fourth port 4 is used as the isolation terminal.

A power amplification method performed by the balanced power amplifier 10 having the above construction will be descried in detail below.

When an input signal Vin is applied to the first port 1 of the first branch-line coupler 20a, the first branch-line coupler 20a divides the input signal Vin into two signals, having the same magnitude and a phase difference of 90°, and outputs the two signals through the second port 2 and the third port 3 via the first series transmission line 22 and the second series transmission line 24.

In this case, the signals output through the second port 2 and the third port 3 each have a magnitude which is ½ of the power intensity of the input signal Vin. Meanwhile, the signals output through the second port 2 and the third port 3 of the first branch-line coupler 20a are amplified by the first and second amplification means 30a and 30b to the same gain, and then the amplified signals are transmitted to the second port 2 and the third port 3 of the second branch-line coupler 20b.

In this case, when the amplified signals are input to the second port 2 and the third port 3 of the second branch-line coupler 20b, the second branch-line coupler 20b modulates the phase of the amplified signal input to the second port 2 by an angle of 90° so that the phase becomes identical to that of the amplified signal input to the third port 3. Thereafter, the second branch-line coupler 20b combines the phase-modulated amplified signal with the amplified signal input to the third port 3, and transmits the combined signal to the first port 1 which is the output terminal Vout.

Accordingly, the input signal Vin amplified by the balanced power amplifier 10 to a predetermined level is transmitted to the outside of the balanced power amplifier 10 through the antenna.

Meanwhile, the signals output through the second port 2 and the third port 3 of the first branch-line coupler 20a are partially reflected by the first amplification means 30a and the second amplification means 30b. The reflected signals pass through the first branch-line coupler 20a via the second port 2 and the third port 3, and are reflected towards the first port 1 and the fourth port 4 of the first branch-line coupler 20a.

In this case, the signal reflected towards the first port 1 of the first branch-line coupler 20a has a phase changed by an angle of 180° from that of the signal output through the second port 2, and the signal reflected towards the fourth port 4 has a phase identical to that of the signal output through the third port 3 and is consumed by an isolation resistor of 50Ω.

Due thereto, the total amount of reflection conducted by the first amplification means 30a and the second amplification means 30b becomes 0.

Meanwhile, a micro-power signal corresponding to the signal, output to the antenna through the first port 1 of the second branch-line coupler 20b, is reflected towards the fourth port 4 of the second branch-line coupler 20b.

The transmission power detection unit 40 is connected to the isolation terminal formed on the output side of the balanced power amplifier 10, that is, the fourth port 4 of the second branch-line coupler 20b, and is configured to amplify a micro-power signal transmitted to the isolation terminal when a transmission power detection signal (Coupler In) is externally received, and to transmit the amplified signal (that is, the current transmission power detection signal of the power amplification module) to the outside of the transmission power detection unit 40.

For this operation, the transmission power detection unit 40 is configured to include a buffer (or a source follower unit) 42 and an amplification unit 44, as shown in FIG. 2. The buffer 42 transfers the externally received transmission power detection signal without causing loss. The amplification unit 44 is connected to the buffer 42 in a cascode structure and is configured to amplify the signal transferred to the isolation terminal of the balanced power amplifier and to transmit the amplified signal (Coupler Out) to the transmission power detection unit of another mode when the buffer 42 is operated by the externally received transmission power detection signal.

The buffer 42 includes a first transistor M1 and a first capacitor C1. The first transistor M1 has a drain which is connected to supply power Vdd, a source which is connected to the amplification unit 44, and a gate which is connected to a transmission power detection signal input terminal (Coupler In) for receiving a transmission power detection signal, that is, the output terminal of the transmission power detection unit of a power amplification module which amplifies a power signal of another mode. The first capacitor C1 is connected between the gate of the first transistor M1 and the transmission power detection signal input terminal (Coupler In) and is configured to eliminate the Direct Current (DC) component of the transmission power detection signal input through the transmission power detection signal input terminal (Coupler In).

Here, the first transistor M1 is implemented as an N-type Metal-Oxide-Semiconductor Field-Effect Transistor (NMOSFET).

In this case, the term ‘transmission power detection unit of another mode’ means a coupler 120a corresponding to a GSM power amplifier 110a or a coupler 120c corresponding to a WCDMA power amplifier 110c when the power amplification module of FIG. 2 is assumed to be a pair of an EDGE power amplifier 110b, among the power amplifiers of FIG. 1, and the coupler 120b.

In the case where the power amplification module according to the embodiment of the present invention is used as a power amplification module for amplifying an EDGE-mode power signal, when a previous power amplification module, that is, a power amplification module for amplifying a GSM-mode power signal, is operated, such a buffer 42 is operated by a transmission power detection signal received from the output terminal of the transmission power detection unit of the previous power amplification module. In contrast, when the previous power amplification module is not operated, the buffer 42 is not operated.

Meanwhile, when the power amplification module according to the embodiment of the present invention is used as a power amplification module for amplifying a GSM-mode power signal, that is, when the power amplification module is arranged at the first location of the power amplification modules for amplifying multi-mode power signals, the gate of the first transistor M1 of the buffer 42 may be connected to a reference voltage source or supply power.

In this case, the buffer 42 is always operated.

The amplification unit 44 includes a second transistor M2, a second capacitor C2, and a third capacitor Cm. The second transistor M2 has a drain which is connected to the source of the first transistor M1, a source which is connected to a ground GND, and a gate which is connected to the isolation terminal of the second branch-line coupler 20b, in order to amplify the signal transmitted to the isolation terminal of the balanced power amplifier 10 and transmit the amplified signal (Coupler Out) to the transmission power detection signal output terminal (Coupler Out), that is, the transmission power detection unit of another mode, when the buffer 42 is operated. The second capacitor C2 is connected between the isolation terminal of the second branch-line coupler 20b and the gate of the second transistor M2 so as to eliminate the DC component of the signal received from the isolation terminal The third capacitor Cm is connected between a common node of the source of the first transistor M1 and the drain of the second transistor M2 and the output terminal (Coupler Out) of the transmission power detection unit 40 and is configured to prevent a DC voltage from being transferred from the output terminal (Coupler Out) of the transmission power detection unit 40 to the common node of the source of the first transistor M1 and the drain of the second transistor M2 while eliminating noise from the signal amplified by the amplification unit 44.

Here, the second transistor M2 is implemented as an NMOSEET.

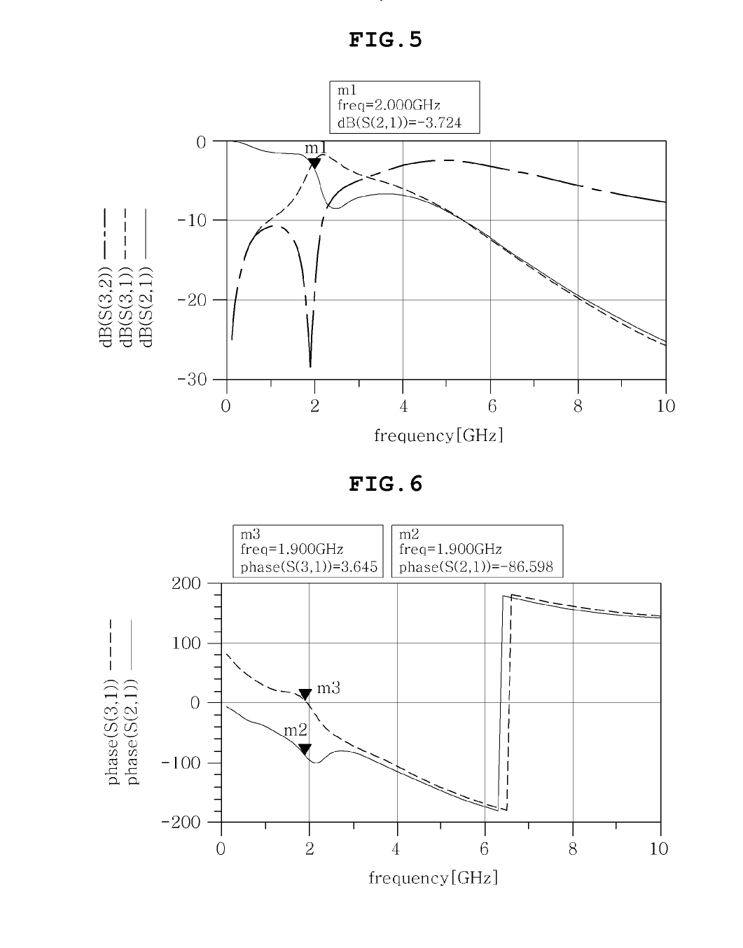

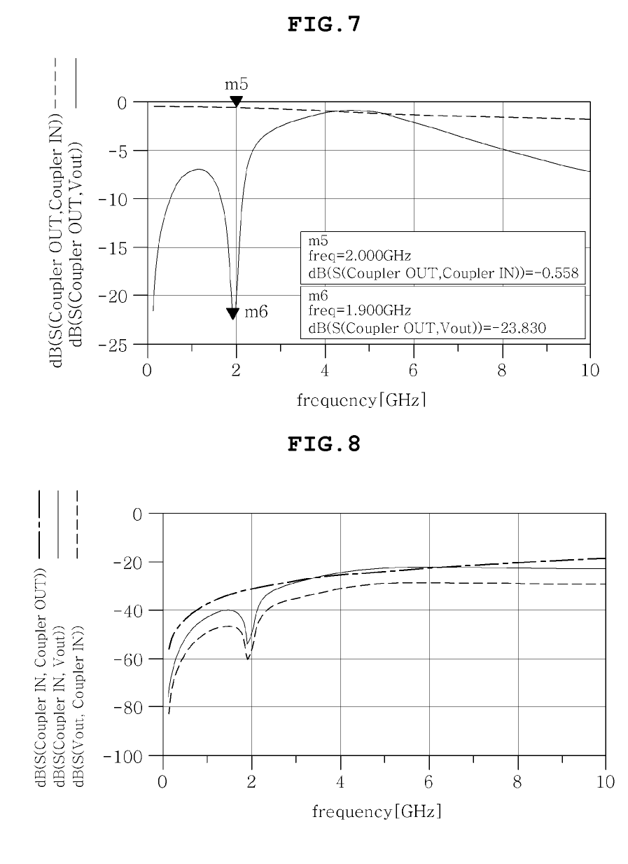

FIGS. 5 and 6 are graphs showing the characteristics of the branch-line coupler of the power amplification module of FIG. 2, and FIGS. 7 and 8 are graphs showing the characteristics of the power amplification module of FIG. 2.

As shown in FIGS. 5 and 6, it can be seen that two signals of 0° and 90° are combined by and output from the branch-line coupler without being influenced by the transmission power detection unit 40, that is, the coupler, in the power amplification module for a mobile communication terminal according to an embodiment of the present invention.

Further, it can be seen in FIG. 7 that, in the power amplification module according to an embodiment of the present invention, a transmission loss rate between power amplification modules is very low.

Furthermore, it can be seen in FIG. 8 that, in the power amplification module according to an embodiment of the present invention, the transmission of signals from the detection signal output terminal (Coupler Out) to the detection signal input terminal (Coupler In) of the transmission power detection unit 40 is scarcely performed, and thus the characteristic of isolation between the detection signal input terminal (Coupler In) and the detection signal output terminal (Coupler Out) is very excellent.

In this way, the power amplification module for a mobile communication terminal according to embodiments of the present invention is configured such that, since the detection signal input terminal (Coupler In) and the detection signal output terminal (Coupler Out) of the transmission power detection unit 40 (that is, the coupler) can be easily implemented using an internal circuit without using external couplers at the output terminal of the balanced power amplifier 10, the power amplification module can be implemented as a one-chip structure.

Further, the power amplification module for a mobile communication terminal according to embodiments of the present invention is characterized in that, since a power amplification module is implemented using lumped elements, the entire size of the power amplification module can be reduced, and in that, since a MOSFET switched according to whether a transmission power detection signal is present is used, the characteristic of isolation between the detection signal input terminal (Coupler In) and the detection signal output terminal (Coupler Out) of the transmission power detection unit 40 can be improved.

As described above, the present invention is advantageous in that, since the detection signal input terminal and the detection signal output terminal of a transmission power detection unit can be easily implemented using an internal circuit without using external couplers at the output terminal of a balanced power amplifier, the power amplification module can be implemented as a one-chip structure.

Further, the present invention is advantageous in that, since a power amplification module is implemented using lumped elements, the entire size of the power amplification module can be reduced, and in that, since a MOSFET switched according to whether a transmission power detection signal is present is used, the characteristic of isolation between the detection signal input terminal and the detection signal output terminal of a transmission power detection unit can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A power amplification module for a mobile communication terminal, comprising:
a balanced power amplifier configured to divide an input signal using a phase difference, amplify resulting signals, and combine the amplified signals with each other; and
a transmission power detection unit connected to an isolation terminal formed on an output side of the balanced power amplifier and configured to amplify a micro-power signal, which is transmitted to the isolation terminal from an outside of the transmission power detection unit, and to transmit the amplified signal to the outside.

2. The power amplification module as set forth in claim 1, wherein the balanced power amplifier comprises:
a first branch-line coupler for dividing the input signal into two signals having an identical magnitude and a phase difference of 90° therebetween;
first amplification means and second amplification means for respectively amplifying the two signals divided by the first branch-line coupler; and
a second branch-line coupler for combining the signals amplified by the first amplification means and the second amplification means with each other.

3. The power amplification module as set forth in claim 2, wherein the signals divided by the first branch-line coupler each have a magnitude which is ½ of power intensity of the input signal.

4. The power amplification module as set forth in claim 1, wherein the transmission power detection unit comprises:
a buffer for transferring an externally received transmission power detection signal; and
an amplification unit connected to the isolation terminal of the balanced power amplifier and connected to the buffer in a cascode structure, the amplification unit amplifying a signal transferred to the isolation terminal of the balanced power amplifier and transmitting the amplified signal to the outside of the transmission power detection unit when the buffer is operated.

5. The power amplification module as set forth in claim 4, wherein the buffer comprises:
a first transistor, a drain of which is connected to supply power, a source of which is connected to the amplification unit, and a gate of which is connected to a transmission power detection signal input terminal for receiving the transmission power detection signal; and
a first capacitor connected between the gate of the first transistor and the transmission power detection signal input terminal so as to eliminate a Direct Current (DC) component of the transmission power detection signal.

6. The power amplification module as set forth in claim 5, wherein the amplification unit comprises:
a second transistor, a drain of which is connected to the source of the first transistor, a source of which is connected to a ground, and a gate of which is connected to the isolation terminal;
a second capacitor connected between the isolation terminal and the gate of the second transistor and configured to eliminate a DC component of a signal received from the isolation terminal; and
a third capacitor connected between a common node of the source of the first transistor and the drain of the second transistor and a transmission power detection signal output terminal.

7. The power amplification module as set forth in claim 6, wherein each of the first transistor and the second transistor is implemented as an N-type Metal-Oxide-Semiconductor Field-Effect Transistor (NMOSFET).
